(19) United States
(12) Patent Application Publication
(10) Pub. No.: US 2024/0249249 A1
(43) Pub. Date: Jul. 25, 2024

(54) INFORMATION PROCESSING DEVICE

(71) Applicant: TOYOTA JIDOSHA KABUSHIKI KAISHA, Toyota-shi (JP)

(72) Inventors: Kota WASHIO, Nagaizumi-cho (JP); Masato ENDO, Nagoya-shi (JP)

(73) Assignee: TOYOTA JIDOSHA KABUSHIKI KAISHA, Toyota-shi (JP)

(21) Appl. No.: 18/536,547

(22) Filed: Dec. 12, 2023

(30) Foreign Application Priority Data
Jan. 23, 2023 (JP) 2023-008034

(51) Int. Cl. G06Q 10/20; G07C 5/02

(52) U.S. Cl. CPC G06Q 10/20; G07C 5/02

(57) ABSTRACT

An information processing device includes a control unit configured to acquire information on user's driving, perform a driving diagnose of a vehicle based on the acquired information, and present an amount of money saved for a component of the vehicle based on a result of the driving diagnosis.

### CROSS-REFERENCE TO RELATED APPLICATION

This application claims priority to Japanese Patent Application No. 2023-008034 filed on Jan. 23, 2023, incorporated herein by reference in its entirety.

### BACKGROUND

### 1. Technical Field

The present disclosure relates to information processing devices.

### 2. Description of Related Art

A technique is known in which a physical quantity that changes based on at least one of traveling, steering, and braking of a vehicle or a physical quantity that changes when a predetermined operation member is operated is detected, and a driving maneuver score is calculated based on a detected value (e.g., Japanese Unexamined Patent Application Publication No. 2022-138727 (JP 2022-138727 A)).

### SUMMARY

It is an object of the present disclosure to provide a technique of presenting a benefit of improving driving to a user.

An aspect of the present disclosure is an information processing device including a control unit. The control unit is configured to acquire information on user's driving, perform a driving diagnosis of a vehicle based on the acquired information, and present to the user an amount of money saved for a component of the vehicle based on a result of the driving diagnosis.

Another aspect of the present disclosure is an information processing method that is performed by the information processing device, a program that causes a computer to perform the information processing method, or a storage medium storing the program in a non-transitory manner.

According to the present disclosure, it is possible to provide a technique of presenting a benefit of improving driving to the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the schematic configuration of the system;

FIG. 2 is a diagram showing an example of a detection information DB;

FIG. 3 is a diagram showing an example of an amount-for-component DB;

FIG. 4 is a flowchart showing an example of the saving amount notification process;

FIG. 5 is a diagram for explaining an example of driving diagnosis results presented to the user; and

FIG. 6 is a flowchart showing an example of a process for determining a fee for a leased vehicle.

### DETAILED DESCRIPTION OF EMBODIMENTS

In the conventional driving diagnosis system, even if the diagnosis result is seen, it is sometimes difficult for the user to understand the benefits of improving driving.

An information processing device according to an aspect of the present disclosure includes a control unit configured to acquire information on user's driving, perform a driving diagnosis of a vehicle based on the acquired information, and present an amount of money saved for a component of the vehicle based on a result of the driving diagnosis.

The driving diagnosis may for example, evaluate the frequency or degree of sudden braking, sudden acceleration, and the like. Driving diagnosis is performed, for example, based on output values of sensors mounted on the vehicle. Vehicle component costs include, for example, the cost of brake pads, tires, or batteries in a battery electric vehicle or hybrid electric vehicle. The saved amount of money represents, for example, the impact of favorable operation on the estimated service life and replacement cost of components when the standard operation is performed. It should be noted that the cost (negative saved amount of money) resulting from unfavorable driving may be presented. As the saved amount of money, the total amount of money saved for a plurality of components may be presented, or the breakdown for each component may be presented. The information processing device may be a server that acquires and processes information from a vehicle, or may be an in-vehicle device.

In this way, expressing the impact of improving driving in monetary terms helps users understand the benefits. As a result, it is possible to motivate the user to improve driving and promote safe driving. In addition, it prevents the user from getting tired of using the driving diagnosis, leading to continued use.

The information processing device may further include a storage unit configured to store a relationship between a diagnostic result for a plurality of items of the driving diagnosis and the amount of money saved for the component of the vehicle. The control unit may obtain the saved amount of money based on the relationship and present the obtained saved amount of money to the user. By determining in advance the relationship between the result of the driving diagnosis and the saved amount of money, the saved amount of money can be quickly obtained.

The control unit may be configured to, when the vehicle is a leased vehicle, set a lease payment according to the saved amount of money. Even in the case of leased vehicles, users can be motivated to improve their driving.

The control unit may present the saved amount of money to the user for each trip. A trip is, for example, a series of runs from a departure point to a destination, and it may be determined that one trip is completed when it is determined that the destination set by the car navigation system has been reached. Further, for example, a trip may be terminated when the vehicle has been stopped for a predetermined time or more, and it may be determined that one trip has been completed when the accessory (ACC) power supply of the vehicle is turned off. Since the saved amount of money is presented to the user for each trip, it becomes easier for the user to understand the correlation between driving and the saved amount of money.

The control unit may display the saved amount of money on a user interface of an application configured to provide the result of the driving diagnosis. The result of the driving diagnosis is a general analysis of driving, and may include items that do not affect calculation of the amount of money saved for the components. By presenting the saved amount of money together with the result of the driving diagnosis, it is possible to make the user recognize that the saving was achieved as a result of using the driving diagnosis.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

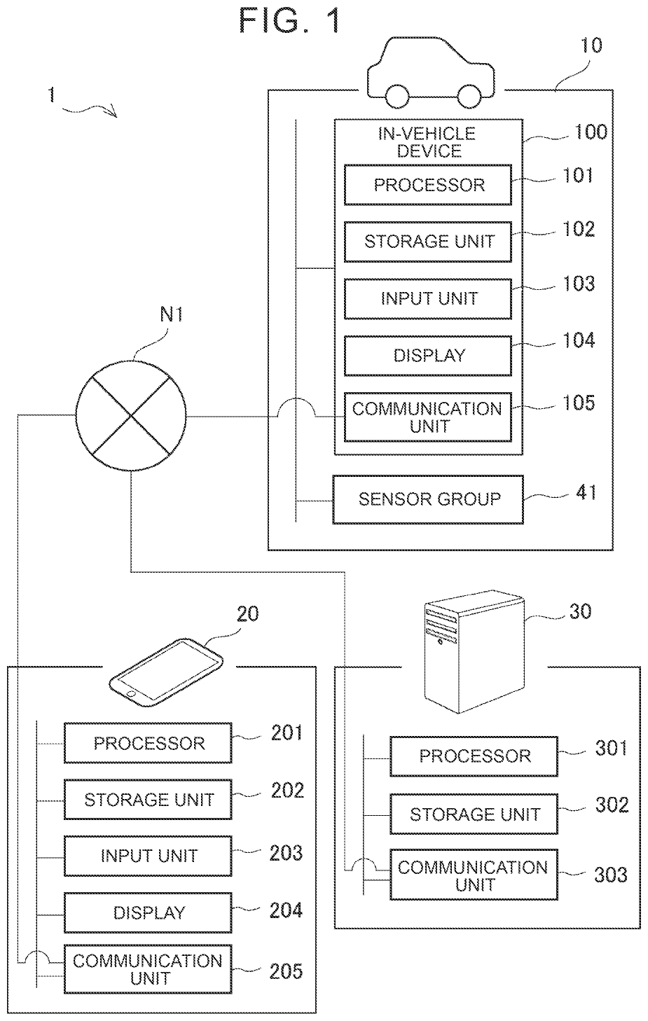

FIG. 1 is a block diagram showing a schematic configuration of a system 1 according to an embodiment. System 1 includes vehicle 10, user terminal 20 and server 30. The system 1 is a system in which a server 30 performs a driving diagnosis based on information on traveling of a vehicle 10 and presents the amount of money saved for components to a user. The saved amount of money is displayed on the in-vehicle device 100 of the vehicle 10 or the user terminal 20.

Vehicle 10, user terminal 20, and server 30 are interconnected by network N1. The network N1 is, for example, a worldwide public communication network such as the Internet, and may be a Wide Area Network (WAN) or other communication networks. In addition, the network N1 may include a telephone communication network such as a mobile phone network and a wireless communication network such as Wi-Fi (registered trademark). Note that the vehicle 10 may be connected to the user terminal 20 via short-range wireless communication. Although FIG. 1 illustrates one vehicle 10 as an example, there may be a plurality of vehicles 10. Further, there may be a plurality of users and user terminals 20 depending on the number of vehicles 10. The user terminal 20 is a mobile terminal owned by the user. The user terminal 20 is registered in the server 30 in association with the vehicle 10.

The server 30 has a computer configuration. The server 30 has a processor 301, a storage unit 302 and a communication unit 303. The components are connected to each other by a bus.

The processor 301 is a Central Processing Unit (CPU), a Digital Signal Processor (DSP), or the like. The processor 301 controls the server 30 and performs various information processing operations. Note that the processor 301 is an example of a control unit. The functions of processor 301 will be described later.

The storage unit 302 includes a main storage device such as Random Access Memory (RAM) and Read Only Memory (ROM). The storage unit 302 also includes an auxiliary storage device such as an Erasable Programmable ROM (EPROM), a Hard Disk Drive (HDD), removable media, and the like. The auxiliary storage device stores an operating system (OS), various programs, various tables, and the like. The processor 301 loads the program stored in the auxiliary storage device into the working area of the main storage device and executes it, and each component and the like are controlled through the execution of this program. As a result, the server 30 realizes the function that matches the predetermined purpose. The storage unit 302 is a computer-readable recording medium. The server 30 may be a single computer or may include a plurality of computers linked together.

The communication unit 303 is means for communicating with the vehicle 10 and the user terminal 20 via the network N1. The communication unit 303 is, for example, a Local Area Network (LAN) interface board or a wireless communication circuit for wireless communication. The LAN interface board and the wireless communication circuit are connected to the network N1.

The series of processes executed by the server 30 can be executed by hardware or software.

Next, the user terminal 20 will be described. The user terminal 20 is, for example, a small computer such as a smart phone, a mobile phone, a tablet terminal, a personal information terminal, a wearable computer (such as a smart watch), or a Personal Computer (PC). The user terminal 20 has a processor 201, a storage unit 202, an input unit 203, a display 204 and a communication unit 205. The components are connected to each other by a bus.

Since the processor 201 and the storage unit 202 are the same as the processor 301 and the storage unit 302 of the server 30, description thereof will be omitted. The processor 201 of the user terminal 20 functions as a control unit. That is, the processor 201 executes the processing according to the embodiment according to the computer program on the storage unit 202. However, part of the processing of the control unit may be executed by a hardware circuit. The user terminal 20 may be installed with application software capable of referring to the result of the driving diagnosis, and the processor 201 may execute this software. Note that the system 1 does not need to include the user terminal 20 when the result of the driving diagnosis can be referred to by the in-vehicle device 100.

The input unit 203 is means for receiving an input operation performed by a user, such as a touch panel, mouse, keyboard, microphone, or push button. A display 204 is means for presenting information to the user, and is, for example, a Liquid Crystal Display (LCD) or an Electroluminescence (EL) panel. The input unit 203 and the display 204 may be configured as one touch panel display.

The communication unit 205 is communication means for connecting the user terminal 20 to the network N1. The communication unit 205 is, for example, a mobile communication service (for example, a telephone communication network such as 6th Generation (6G), 5th Generation (5G), 4th Generation (4G), 3rd Generation (3G), Long Term Evolution (LTE)), Wi-Fi (registered trademark), Bluetooth (registered trademark), etc., to communicate with other devices (for example, vehicle 10 or server 30) via network N1.

Next, the vehicle 10 will be described. The vehicle 10 includes an in-vehicle device 100 that is a computer, and a sensor group 41. These components are interconnected by a CAN bus, which is the bus of the in-vehicle network. Each of these components may be implemented by a combination of an Electronic Control Unit (ECU), an in-vehicle communication device, or the like instead of a single module.

The in-vehicle device 100 has a configuration of a computer. The in-vehicle device 100 includes a processor 101, a storage unit 102, an input unit 103, a display 104 and a communication section 105. The components are connected to each other by a bus. The processor 101, storage unit 102, input unit 103, display 104, and communication unit 105 are the same as the processor 201, storage unit 202, input unit 203, display 204, and communication unit 205 of the user terminal 20, the description is omitted. Note that the processor 101 of the in-vehicle device 100 functions as a control unit. That is, the processor 101 of the in-vehicle device 100 executes the processing according to the embodiment according to the computer program on the storage unit 102. However, part of the processing of the control unit may be executed by a hardware circuit. The in-vehicle device 100 may be installed with application software capable of referring to the results of driving diagnosis, and processor 101 may execute this software. Note that if the user terminal 20 can refer to the result of the driving diagnosis, the in-vehicle device 100 may not include the input unit 103 and the display 104, and the in-vehicle device 100 may be an ECU having a communication function.

The sensor group 41 includes, for example, sensors that detect the state of the vehicle 10 and sensors that detect the actions of the driver. The sensor group 41 includes a wheel speed sensor or an accelerator operation amount sensor. The sensor group 41 includes, for example, a speed sensor, an acceleration sensor, a steering angle sensor, a yaw rate sensor, a winker switch sensor (a sensor that detects the switch state of a direction indicator), a shift position sensor, and a position information sensor (GPS sensor), brake switches, or sensors that detect that systems such as pre-crash safety have been activated. The processor 101 of the in-vehicle device 100 transmits information about each detection value of the sensor group 41 to the server 30 at each predetermined time or every trip. At this time, the information may be transmitted together with the vehicle ID, position information, time information, etc. as travel information.

Next, the function of the server 30 will be described. The processor 301 of the server 30 functions as a control unit. That is, the processor 301 of the server 30 executes the processing according to the embodiment according to the computer program on the storage unit 302.

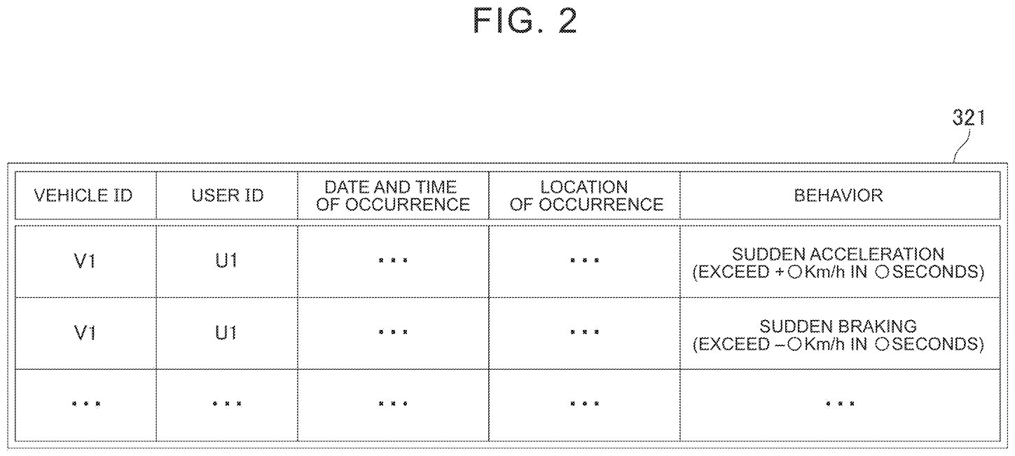

FIG. 2 is a diagram showing an example of the detection information DB 321 stored in the storage unit 302 of the server 30. Each DB stored in the storage unit 302 is, for example, a relational database. The DB may be normalized and stored separately in a plurality of tables, or may be non-normalized and collectively stored in one table.

The processor 301 updates the detection information DB 321 when detecting a predetermined behavior in the travel information acquired from the vehicle 10. The detection information DB 321 has fields of vehicle ID, user ID, date and time of occurrence, location of occurrence, and behavior. Each record of the detection information DB 321 is generated each time a predetermined behavior is detected. Identification information for uniquely identifying a vehicle is registered in the vehicle ID field. Identification information for uniquely identifying the user who drives the vehicle is registered in the user ID field. Information on the date and time when a predetermined behavior occurred is input to the date and time of occurrence field. Information on the location where a given behavior occurred is input to the location of occurrence field. This position is determined using, for example, a satellite positioning system that performs position measurements using signals emitted by artificial satellites. Information on the detected behavior is input to the behavior field. The behavior may include, for example, information representing the degree of sudden acceleration, sudden braking, and the like. Each field of the detection information DB 321 is illustrative, and the user ID and the location of occurrence may not be included.

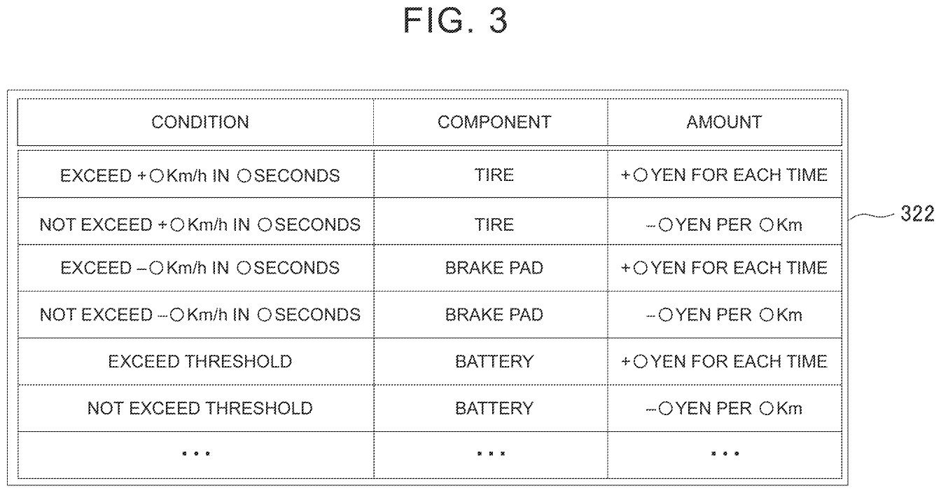

For example, when the processor 301 determines that one trip has been completed in the vehicle 10, the processor 301 calculates the amount of money saved for components of the vehicle and present the calculated saved amount of money to the user. The saved amount of money is obtained using, for example, the amount-for-component DB 322 shown in FIG. 3. FIG. 3 is a diagram showing an example of the amount-for-component DB 322 stored in the storage unit 302 of the server 30. The amount-for-component DB 322 stores the relationship between the diagnosis results corresponding to a plurality of items of the driving diagnosis and the amount of money saved for the components of the vehicle. The amount-for-component DB 322 has fields of condition, component, and amount. It is assumed that each record in the amount-for-component DB 322 is registered in advance. The condition under which the saved amount of money fluctuates as a result of the diagnosis is registered in the condition field. The condition may be the frequency of behavior per travel distance registered in the detection information DB 321 shown in FIG. 2. The condition may also be a statistic such as an average of values representing the degree of behavior registered in the detection information DB 321. Also, the condition may be the occurrence of the behavior registered in the detection information DB 321 itself. Components that affect wear and deterioration by satisfying the conditions of each record are registered in the component field. For example, rapid discharge due to rapid acceleration accelerates deterioration of the battery. Sudden acceleration also prematurely wears tires, especially in battery electric vehicles. Sudden braking also accelerates wear of the brake pads. In the example of FIG. 3, the battery, tire, and brake pad are illustrated, but the saved amount of money may not be calculated for at least some of them, or the amount of money saved for other components may be calculated. Information indicating the amount of change in the saved amount of money when the condition in each record is satisfied is registered in the amount field. In addition, in the example of FIG. 3, the amount of money saved is represented by a negative value. For example, based on the life of the components and the unit price of the components in the case of standard operation as a reference, variations in the prices of the components (saved amount of money or increase in cost) according to the life of the components that are extended or shortened when the result of the driving diagnosis satisfies predetermined conditions are calculated in advance. In the calculation of the saved amount, the fluctuation of the amount may be such that the amount registered in the amount-for-component DB is integrated each time the condition is satisfied. Also, the amount of money may be accumulated according to the distance traveled without detecting a predetermined behavior. Also, the amount of money may be accumulated according to a predetermined statistic and travel distance. The saved amount of money may vary for each product, even for tires, for example, so the amount-for-component DB 322 may have a record for each product identification information. In this case, the identification information of the components mounted on each vehicle 10 is registered, and the corresponding record is obtained from the amount-for-component DB according to the identification information of the components.

The processor 301 can calculate, for example, the amount of money saved for components in one trip, based on the information stored in the detection information DB 321 of FIG. 2 and the amount-for-component DB 322 of FIG. 3.

### Saving Amount Notification Processing

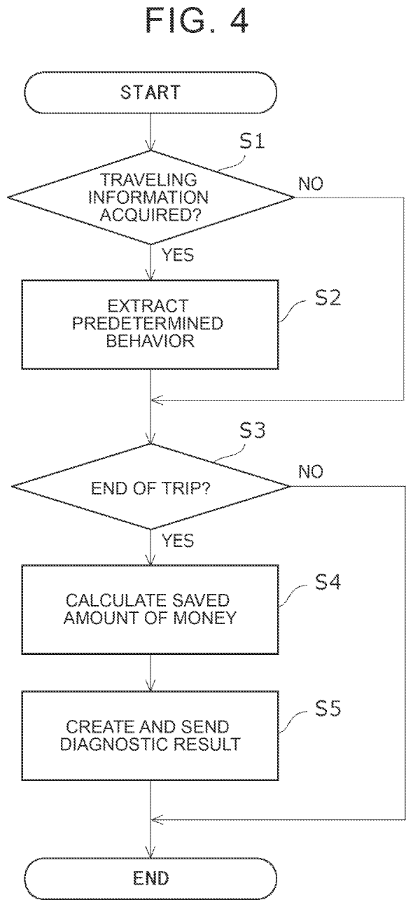

Next, processing executed by the server 30 will be described. FIG. 4 is a flowchart showing an example of the saving amount notification process. The processing of FIG. 4 is continuously executed in the server 30. First, the processor 301 of the server 30 determines whether or not new travel information has been acquired (FIG. 4: S1). In this step, when the travel information is received from the vehicle 10 via the network N1 and the communication unit 303, a positive determination is made. When the travel information is received via the communication unit 303, the processor 301 stores the travel information in the storage unit 302. If it is determined that new travel information has not been acquired from the vehicle 10 (S1: NO), the process proceeds to S3.

On the other hand, when it is determined that new travel information has been acquired from the vehicle 10 (S1: YES), the processor 301 extracts a predetermined behavior from the travel information (FIG. 4: S2). In this step, for example, sudden acceleration and sudden braking are extracted. Sudden acceleration and braking can be determined to have occurred, for example, when a measured wheel speed or a measured accelerator operation amount, or a value based on these measured values, exceeds a predetermined threshold or falls below a predetermined threshold. In this step, information such as that shown in the detection information DB 321 of FIG. 2, for example, is extracted.

The processor 301 also determines whether one trip has ended (FIG. 4: S3). For example, it may be determined that one trip has been completed when information is received from the vehicle 10 indicating that the destination set in the car navigation system of the vehicle 10 has been reached. Further, for example, when the travel information is not received from the vehicle 10 for a predetermined period of time or longer (that is, when the vehicle stops for a predetermined period of time or longer), it may be determined that the trip has ended. Alternatively, it may be determined that one trip is completed when the accessory power source of the vehicle is turned off. Further, when the vehicle 10 collectively transmits travel information at the end of a trip, it may be determined that one trip has been completed when it is determined that the travel information has been received in S1. If it is determined that one trip has not been completed (S3: NO), the process of FIG. 4 is terminated.

On the other hand, if it is determined that one trip has been completed (S3: YES), the amount of money saved for components is calculated (FIG. 4: S4). In this step, for example, when the requirements registered in the condition field of the amount-for-component DB 322 are met based on the behavior that occurred during the period of one trip, the amount of money registered in the amount field is added. The saved amount of money may be calculated for each component.

The processor 301 creates and transmits the result of driving diagnosis (FIG. 4: S5). It is assumed that the information indicating the result of the driving diagnosis includes the amount of money saved for the components. In this step, the processor 301 creates information to be presented to the user via the user terminal 20 or the in-vehicle device 100, and transmits the information to the user terminal 20 or the in-vehicle device 100 via the network N1. Then, the processing of FIG. 4 ends.

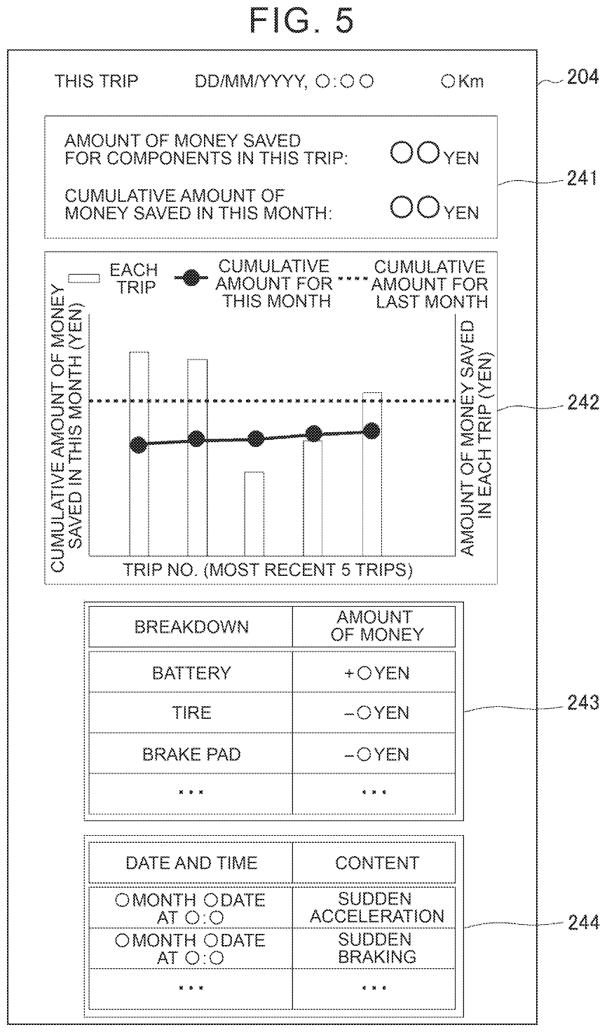

FIG. 5 is a diagram for explaining an example of the driving diagnosis result presented to the user. For example, the display 204 of the user terminal 20 includes an amount of money 241 saved for components, a graph 242 representing the saved amount of money, a breakdown 243 of the amounts of money saved for each component, and a history 244 of behavior that affects the amount of money to be saved. It should be noted that items other than the amount of money 241 saved for the components need not necessarily be presented. In addition, the amount of money 241 saved for the components may include the cumulative saved amount of money in the current month in addition to the amount of money saved in the current trip. The graph 242 may include the amount of money saved in the predetermined number of most recent trips (bar graph in FIG. 5), the cumulative saved amount of money in the current month (line graph in FIG. 5), and the cumulative saved amount of money in the previous month (broken line in FIG. 5). Even if the amount of money saved in one trip is relatively small, the cumulative amount makes it easier to realize the effect of driving improvement. FIG. 5 is a user interface for an application that provides the result of driving diagnosis and may display a history 244 of behavior that affects the amount of money to be saved. In S5 of FIG. 4, information for displaying a screen as shown in FIG. 5, for example, is transmitted.

### Effect

As described above, according to the present embodiment, it is possible to present the benefit of improving driving to the user by the amount of money saved for components. Since the effect is easy for the user to understand, it is possible to promote improvement of driving.

### Second Embodiment

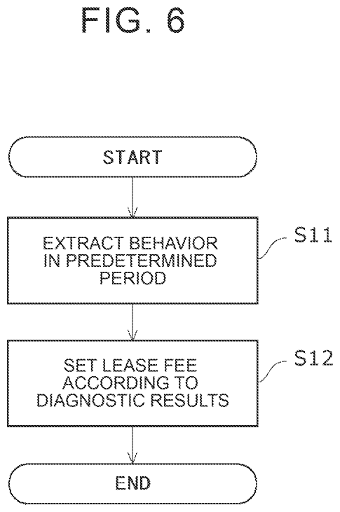

Vehicle 10 may be a lease vehicle. FIG. 6 is a flowchart showing an example of a process for determining a fee for a leased vehicle. When the vehicle 10 is a leased vehicle, the processor 301 of the server 30 may set a lease payment according to the saved amount of money. The processor 301 reads the behavior of the vehicle 10 for a predetermined period from the detection information DB 321 (FIG. 6: S11). For example, when renewing a lease contract, the behavior during the past contract period may be read. Also, the monthly charge for the next month may be changed based on the behavior of the previous month. Also, the processor 301 determines a lease fee according to the diagnosis result for a predetermined period (FIG. 6: S12). In this step, for example, based on a predetermined payment system, the larger the amount of money saved for the components, the lower the lease payment. According to this embodiment, the user of the leased vehicle can be motivated to improve driving.

### Other Embodiments

The above embodiment is merely illustrative, and the present disclosure may be modified as appropriate without departing from the spirit and scope of the disclosure. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

For example, the in-vehicle device 100 of the vehicle 10 may have some or all of the functions of the server 30. That is, the in-vehicle device 100 may perform the driving diagnosis and the calculation of the amount of money saved for the components. The result of driving diagnosis shown in FIG. 5 may be displayed on the display 104 of the in-vehicle device 100 instead of the display 204 of the user terminal 20.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit, the control unit being configured to
acquire information on user's driving,
perform a driving diagnosis of a vehicle based on the acquired information, and
present to the user an amount of money saved for a component of the vehicle based on a result of the driving diagnosis.

2. The information processing device according to claim 1 further comprising a storage unit configured to store a relationship between a diagnostic result for a plurality of items of the driving diagnosis and the amount of money saved for the component of the vehicle, wherein the control unit is configured to obtain the saved amount of money based on the relationship and present the obtained saved amount of money to the user.

3. The information processing device according to claim 1, wherein the control unit is configured to, when the vehicle is a leased vehicle, set a lease payment according to the saved amount of money.

4. The information processing device according to claim 1, wherein the control unit is configured to present the saved amount of money to the user for each trip.

5. The information processing device according to claim 1, wherein the control unit is configured to display the saved amount of money on a user interface of an application configured to provide the result of the driving diagnosis.
